(19) United States
(12) Patent Application Publication
(10) Pub. No.: US 2001/0009735 A1
(43) Pub. Date: Jul. 26, 2001

(54) Metal-gas cell battery with soft pocket

(76) Inventors: De Qian Yang, Diamond Bar, CA (US); Yu Qiang Yang, Diamond Bar, CA (US)

Correspondence Address: SHELDON & MAK, INC, 225 SOUTH LAKE AVENUE, 9TH FLOOR, PASADENA, CA, 91101, US

(21) Appl. No.: 09/681,260

(22) Filed: Mar. 9, 2001

(51) Int. Cl. H01M 10/34; H01M 10/52; H01M 10/26; H01M 2/12

(52) U.S. Cl. 429/59; 429/101; 429/206; 429/86; 429/128

(57) ABSTRACT

A metal-gas cell storage battery, such as a zinc-air cell battery, has one or more battery cells wherein each battery cell comprises a metallic anode sandwiched between a pair of gas cathodes. Each gas cathode is disposed within a rigid retaining structure. The retaining structures of each gas cathode are attached to one another by an expandable soft pocket capable of holding an electrolyte. The anode is disposed within the soft pocket. The cell is mechanically refueled by expanding the soft pocket to allow easy removal from the cell of the spent anode and easy insertion into the cell of a fresh anode.

### BACKGROUND OF INVENTION

This invention relates generally to metal-gas cell batteries, such as metal-air cell batteries, and, more particularly, to mechanically rechargeable metal-air cell batteries.

More powerful, longer-lasting batteries are a high priority item for all countries seeking to replace hydrocarbon fueled vehicles with smogless electrically powered vehicles. In this regard, a great deal of research is presently focused on metal-gas cell batteries, such as zinc-air batteries. Zinc-air batteries have among the highest theoretical specific energy content of all known battery types. Many problems, however, must be overcome before vehicles powered by zinc-air batteries are regarded as acceptable alternatives to hydrocarbon burning vehicles.

All metal-gas cell batteries comprise a plurality of cells wherein each cell has at least one gas-diffusion cathode and a metallic anode separated by a quantity of alkaline electrolyte and some form of mechanical separation sheet. In the operation of metal-gas cell batteries, a reactant gas, such as oxygen, reacts at each gas-diffusion cathode to form anions. At each anode, the anions react with metallic anode material. The process creates an electrical potential between each cathode and each anode. When the cells are connected in series, the combined electrical potential of all of the cells can be considerable, and can be used as a source of electrical power. As can be seen, however, the operation of the battery gradually depletes the available metallic anode material and the battery has to be periodically recharged.

Metal-gas cell batteries can be recharged either electrically or mechanically. Electrical recharging can be easily adapted to existing power networks, but electrically rechargeable batteries have a markedly limited service life. Moreover, an electrically rechargeable metal-gas battery requires a bi-functional or additional gas diffusion electrode. Having to use such a bi-functional or additional gas diffusion electrode requires that the battery be unduly heavy, bulky and complicated.

Accordingly, the recharging mode of choice for metal-gas cell batteries is presently mechanical refueling, whereby the spent metallic anode is physically replaced with a fresh anode. Mechanical refueling can be accomplished in two ways. In a first way, the metallic anode is comprised of metallic pellets or powder suspended within the electrolyte. When the metallic pellets or powder becomes spent, the metallic pellets or powder is pumped from the cell and fresh pellets or powder is pumped into the cell. U.S. Pat. Nos. 3,981,747, 5,006,424, 5,434,020 and 5,558,947 disclose attempts to use zinc particles or pellets as anodes.

The second way of mechanically refueling a metal-gas battery is far simpler than the first way. In the second way, the metallic anode is a rigid structure. When the metallic anode becomes spent, the anode is removed and a replacement anode is reinstalled into the cell. Because of its simplicity in theory, construction, maintenance and operation, the second of the two refueling methods is generally employed. U.S. Pat. Nos. 3,513,030, 5,203,526, 5,318,861, 5,366,822, 5,418,080, 5,447,805, 5,753,384, 5,904,999 and 6,057,053 all disclose various methods of mechanically refueling metal-gas cell batteries by changing out a rigid anode structure. Each of the patents listed in the immediately previous sentence are incorporated herein by this reference in their entireties.

One problem with such prior art metal-gas cell batteries is the difficulty with which the rigid anode structures are removed from the cell and inserted into the cell. In a conventional cell where the supporting structure is wholly rigid, clearances for the removal and reinsertion of such anodes are generally very small. The gas cathodes and separator sheets are often abraded during the removal and reinsertion of the anodes. U.S. Pat. Nos. 4,389,466 and 4,560,626 disclose an attempt to solve this problem. However, the total contact area between the cone-shaped current collectors and the metallic anodes used in the batteries disclosed in these patents is not sufficient for large currents. Moreover, pinpoints on the current collectors in the batteries disclosed in these patents often make the insertion and extraction of the metallic anodes very difficult. Another attempt to solve this problem is disclosed in U.S. Pat. No. 5,286,578. In this patent, it is suggested to make a metal-gas cell battery with a wholly flexible housing. However, such housing is fragile and cannot withstand repeated refueling. Other wholly flexible housing systems are disclosed in U.S. Pat. Nos. 5,415,949 and 5,650,241. Such housing systems are unduly complex and are therefore expensive to manufacture, maintain and operate.

Another problem with metal-air cell batteries, which are mechanically refueled by physical replacement of a rigid anode structure is the frequent leakage of the alkaline electrolyte. In most prior art designs, the housing of the metal-gas cell is usually opened at the top. The opening is sealed during operation by some form of elastic sealing element disposed between the cell housing and a protruding portion of the anode assembly. This protruding portion of the anode assembly is universally used in such designs for electrical connection to battery electrodes. Moreover, it is common to provide one or two small breathing holes along the uppermost portion of the cell proximate to the protruding portion of the anode. However, alkaline solution tends to creep up the anode and out of the cell along the protruding portion of the anode. Also, alkaline mist continuously escapes through the breathing holes. Such leakage and mist can cause rapid oxidation of the conductors above the anode and the air cathode. Oxidation dramatically increases the electrical resistance between the contacted surfaces and therefore results in a marked loss of battery power. Moreover, the continuing leaking of alkaline electrolyte and electrolyte mist makes the battery difficult to use in any kind of environment where oxidation of metallic items outside of the battery is a problem. Finally, any upset of the battery during handling or operation will cause copious leakage of electrolyte out of the battery.

Accordingly, there is a need for a metal-gas cell battery which is conveniently rechargeable by mechanical replacement of anode material and which avoids the aforementioned problems in the prior art.

### SUMMARY OF INVENTION

The invention satisfies this need. The invention is a metal-gas cell storage battery comprising at least one battery cell. Each battery cell comprises (i) a first gas cathode disposed within a rigid planar first retaining structure, the first gas cathode being permeable to air but impermeable to liquids, the first gas cathode allowing the passage of gases into the cell, (ii) a second gas cathode disposed within a rigid planar second retaining structure, the second gas cathode being permeable to air but impermeable to liquids, the second gas cathode allowing the passage of gases into the cell, the second retaining structure being moveable with respect to the first retaining structure between a first retaining structure position wherein the first retaining structure is proximate to the second retaining structure and a second retaining structure position wherein the first retaining structure is spaced apart from the second retaining structure, the second gas cathode being electrically connected to the first gas cathode, (iii) a soft pocket disposed between the first gas cathode and the second gas cathode, the soft pocket having a flexible and planar first wall and a flexible and planar second wall, the first wall having a periphery and a central opening, the periphery of the first wall including a top edge, the second wall having a periphery and a central opening, the periphery of the second wall including a top edge, the periphery of the first wall connected to the periphery of the second wall except along the respective top edges, the periphery of the first wall being attached to the first retaining structure and the periphery of the second wall being attached to the second retaining structure, whereby the first retaining structure, the first gas cathode, the first wall, the second wall, the second retaining structure and the second gas cathode cooperate to define a liquid retaining soft pocket chamber having a soft pocket lower portion, a soft pocket upper portion and a soft pocket top opening defined between the top edges of the first and second walls, the soft pocket top opening being open in the second retaining structure position and tightly closed in the first retaining structure position, (iv) a soft pocket closing mechanism for securing the first and second retaining structures in the first retaining structure position, and (v) a metallic anode disposed within the soft pocket chamber.

The cell further comprises a positive first battery positive terminal electrically conected to the two gas cathodes and a negative second battery negative terminal electrically connected to the metallic anode.

In a typical embodiment of the invention, the gas cathode is an air cathode and the metallic anode is comprised substantially of metallic zinc.

In a preferred embodiment of the invention, the metallic anode is wholly disposed within the soft pocket chamber.

In another embodiment of the invention, the battery further comprises a second semi-permeable membrane disposed within the upper portion of the soft pocket chamber to reduce the pressure difference between the soft pocket chamber and the outside atmosphere.

In a typical embodiment, the soft pocket closing mechanism is provided by one or more straps which circumscribe the one or more cells.

The invention provides a metal-gas cell battery, such as a zinc-air battery, which is suitable for rapid refueling and which is sufficiently durable for hundreds of refueling operations. The invention also provides a metal-gas cell battery which does not leak electrolyte or electrolyte mist.

### BRIEF DESCRIPTION OF DRAWINGS

These and other features, aspects and advantages of the present invention will become better understood with reference to the following description, appended claims and accompanying drawings where:

FIG. 1 is a perspective view of a metal-gas battery having features of the invention;

FIG. 2 is a perspective view of a metal-gas cell useable in the battery of FIG. 1;

FIG. 3 is a perspective view of an anode useable in the battery of FIG. 1;

FIG. 4 is an exploded view of the cell housing shown in FIG. 2;

FIG. 5 is a perspective view of a pair of gas cathodes useable in the cell of FIG. 2;

FIG. 6 is an exploded view of a pair of cells useable in the invention;

FIG. 7 is a perspective view of the pair of cells shown in FIG. 6;

FIG. 8 is a cross-section view of two cells such as those illustrated in FIG. 7; and

FIG. 9 is a detailed view of the circled area in FIG. 8.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a metal-gas cell battery 10 comprising at least one battery cell 20, a positive first battery terminal 2 and a negative second battery terminal (not shown). Typically, the battery 10 of the invention comprises a plurality of identical battery cells 20. In the discussion which follows, a typical embodiment is described wherein the battery 10 comprises a plurality of battery cells 20, the reactive gas is oxygen, such as from air, and the anode material is zinc or similar material.

Each battery cell 20 comprises a first gas cathode 4, a second gas cathode 6 and a soft pocket 40 disposed between the first gas cathode 4 and the second gas cathode 6. The soft pocket 40 defines a soft pocket chamber 60. Each battery cell 20 further comprises a metallic anode 30 disposed within the soft pocket chamber 60. In a preferred embodiment, but not required, embodiment of the invention, the metallic anode 30 is wholly disposed within the soft pocket chamber 60.

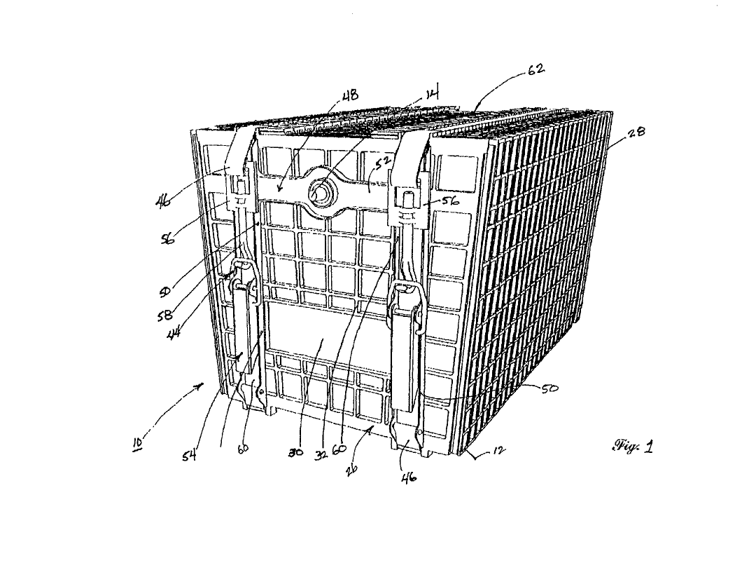

In the embodiment illustrated in FIG. 1, the battery of the invention 10 is a zinc-air battery comprising battery cells 20 connected in series. The battery 10 can comprise any number of battery cells 20, depending upon what voltage is desired.

The battery 10 comprises a front cover plate 8 and a rear cover plate 12. The cover plate 8 protects the outermost gas cathode 4 in the first battery cell and the cover plate 12 protects the outermost gas cathode 6 in the last battery cell.

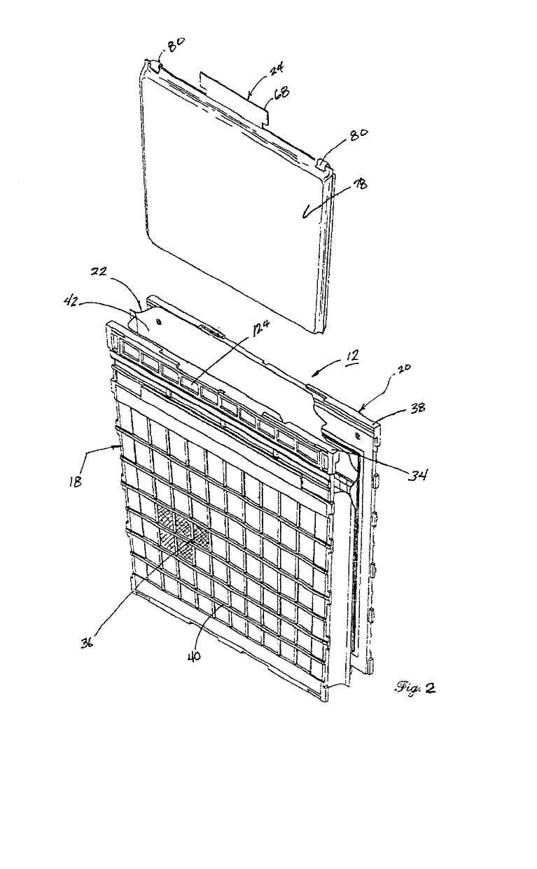

FIGS. 2-9 illustrate a typical cell 20 useable in the battery 10. Each first gas cathode 4 is a gas cathode disposed within a rigid planar first retaining structure 14. The first gas cathode 4 is permeable to a reactive gas but impermeable to liquids. Where the reactive gas is atmospheric oxygen, the first gas cathode 4 allows the passage of oxygen from the atmosphere into the cell 20.

The second gas cathode 6 is disposed within a rigid planar second retaining structure 16. The second gas cathode 6 also is permeable to a reactive gas but impermeable to liquids. Where the reactive gas is atmospheric oxygen, the second gas cathode 6 allows the passage of oxygen from the atmosphere into the cell 20.

The second retaining structure 16 is moveable with respect to the first retaining structure 14 between a first retaining structure position, wherein the first retaining structure 14 is proximate to the second retaining structure 16, and a second retaining structure position wherein the first retaining structure 14 is spaced apart from the second retaining structure 16.

Both the first gas cathode 4 and the second gas cathode 6 comprise a supporting lattice structure 18 which allows sufficient air flow through the gas cathodes 4 and 6.

The soft pocket 40 has a soft pocket top opening 22 which is open in the second retaining structure position and which is tightly closed in the first retaining structure position. By “tightly closed,” it is meant that the soft pocket top opening 22 is sufficiently sealed to prevent the leakage of electrolyte or electrolyte fumes from the soft pocket chamber 60.

As illustrated in FIG. 1, a soft pocket closing mechanism 24 is provided for securing the first and second retaining structures 14 and 16 in the first retaining structure position. In the embodiment illustrated in the drawings, the soft pocket closing mechanism 24 is provided by a pair of straps 26. In other embodiments, a single strap 26 can be used. In still other embodiments, one or more clamps can be used. In still further other embodiments, screws (not shown) protruding from the front cover plate 8 to the rear cover plate 12 can be used.

In the embodiment illustrated in the drawings, each of the straps 26 can be a conventional packing strap made from polypropylene or other suitable material. In the embodiment illustrated in FIG. 1, the opposed ends of each strap 26 are affixed to an H-shaped structure 28 having a pair of parallel vertical members 32 and a single lateral member 34. Both the vertical members 32 and the lateral member 34 can be U-shaped in cross-section to provide structural rigidity. An H-shaped structure 28 is affixed to both the front cover plate 8 and the rear cover plate 12, for example, by screws.

As can be seen from FIG. 1, both of the vertical members 32 on the H-shaped structure 28 comprise latch mechanisms 36 for tightening down on the pair of straps 26. The lower end of each strap 26 is attached to a latch mechanism 36 at the lower end of one of the vertical members 32 by a pin 38, and the upper ends of each strap 26 are attached to an attachment ring 42 disposed proximate to the upper end of one of the vertical members 32. Each attachment ring 42 has a threaded hook 44 which can be adjustably threaded into the attachment ring 42 or threaded out of the attachment ring 42. Each hook 44 is disposed such that it can be engaged by one of the two latch mechanisms 36.

The H-shaped structure 28 on the rear cover plate 12, however, has no latching mechanisms 36, pin 38, rings 42 or hooks 44. On the rear cover plate 12, each of the two straps 26 are retained within one of the U-shaped troughs 46 in the two vertical elements 32.

The positive first battery terminal 2 can be a male cone-shaped structure disposed in the front cover plate 8 as illustrated in FIG. 1. The negative second battery terminal can be a corresponding female cone-shaped structure disposed in the rear cover plate 12. The first battery terminal 2 is electrically connected to the two gas cathodes 4 and 6 which adjoins the first terminal 2. The second battery terminal is electrically connected to the anode 30 which adjoins the second battery terminal.

Air for providing cooling and reactive oxygen to the battery 10 can be flowed through the battery 10 through gaps 52 disposed between the battery cells 20.

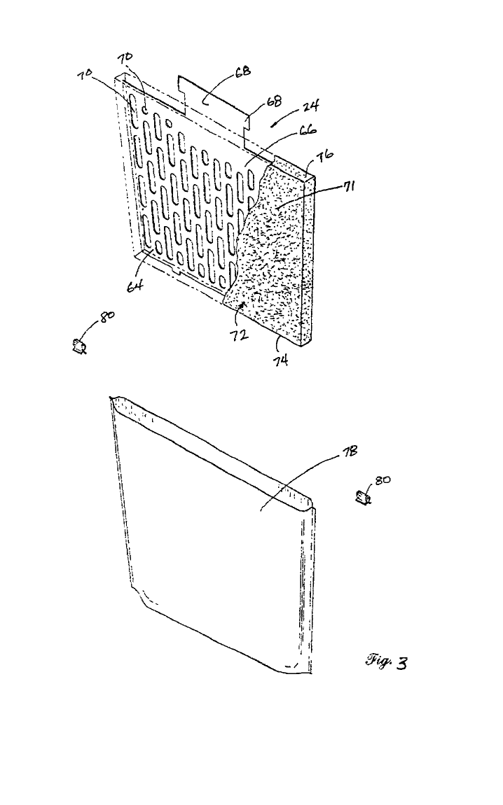

In the embodiment illustrated in the drawings, the anode 30 is wholly disposed within the soft pocket 40. FIG. 3 illustrates a typical anode 30 in detail. In the embodiment illustrated in FIG. 3, the anode 30 comprises an electrically conductive support structure 54 having a support structure base portion 56 and a support structure tab portion 58 disposed above the support structure base portion 56. The support structure base portion 56 and the tab portion 58 can be made from any conductive material. Copper is a preferred material because of its low cost, rigidity and high conductivity. The support structure base portion 56 should be rigid enough to minimize damage or distortion during recycling, and should provide a large cross-sectional area to allow high current flow with minimal voltage drop. In the embodiment illustrated in FIG. 3, holes and slots 62 are disposed within the support structure base portion 56 to reduce the weight of the support structure 54 and to join the metal powder 64 (discussed immediately below) on both sides of the support structure base portion 56 into an integral whole.

A metal powder 64, such as zinc powder, is pressed onto the support structure base portion 56 to provide an anode base portion 66. Preferably, the holes and slots 62 in the support structure base portion 56 are located and configured such that the electrical resistance between all particles of the zinc powder 64 and the support structure anode base portion 66 is nearly identical.

The anode base portion 66 is preferably planar and shaped to provide a large surface area. To facilitate the installation of the anode 30 into the soft pocket 40, it is also preferable that the lowermost edge 68 of the anode base portion 66 be shorter than the length of the uppermost edge 72 of the anode base portion 66. Thus, in a typical embodiment, the anode base portion 66 is trapezoidal in shape with the lowermost edge 68 of the anode base portion 66 being slightly shorter in length than the uppermost edge 72 of the anode base portion 66. In such embodiments, it is also typical for the soft pocket 40 to have an equivalent shape.

The tab portion 58 of the support structure 54 provides a convenient handle which is useful in the installing and de-installing of the anode 30 from the soft pocket 40. The tab portion 58 further provides an electrical connection means for the anode 30 as described below. In those preferred embodiments wherein the anode 30 is wholly disposed within the soft pocket 40 during operation, the tab portion 58 needs no sealing elements.

The anode base portion 66 is disposed within an enclosure bag 60 as illustrated in FIGS. 2 and 3. The enclosure bag 60 can be any suitable porous flexible material, such as a porous plastic membrane, woven fabric or non-woven fabric. The enclosure bag 60 is held in place around the anode base portion 66 by a pair of clips 74.

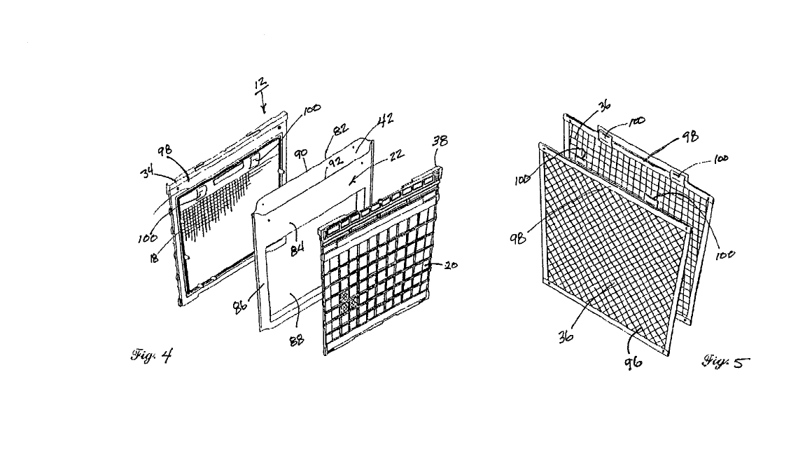

FIG. 4 illustrates an exploded view of the battery cell 20 illustrated in FIG. 2. As can be seen from this view, the soft pocket 40 comprises a flexible and planar first wall 76 and a flexible and planar second wall 78. Both the first wall 76 and the second wall 78 have a periphery 85 and a central opening 84. The periphery 85 of the first wall 76 includes a top edge 86 and the periphery 85 of the second wall 78 also comprises a top edge 88. In the embodiment illustrated in the drawings, the periphery 85 of the first wall 96 further comprises left right edges 82 and the periphery 85 of the second wall 78 further comprises a left and right edges 82. The periphery 85 of the first wall is attached to the first retaining structure 14 by adhesives or other similar attachment means. Similarly, the periphery 85 of the second wall 78 is attached to the second retaining structure 16 by adhesives or other similar attachment means. By this design, the first retaining structure 14, the first gas cathode 4, the first wall 76, the second wall 78, the second retaining structure 16 and the second gas cathode 6 cooperate to enclose the soft pocket 40 so as to form the soft pocket chamber 60. The soft pocket chamber 60 is open at the top opening 22 defined between the two top edges 86 and 88 of the first wall 76 and the second wall 78. When electrolyte is disposed within the soft pocket chamber 60, such electrolyte is in contact with the first gas cathode 4 via the central opening 84 in the first wall 76 and the electrolyte is similarly in contact with the second gas cathode 6 through the central opening 84 in the second wall 78.

The planar walls 76 and 78 of the soft pocket 40 can be made from a plastic membrane or other suitable material. The first and second walls 76 and 78 of the soft pocket 40 can be made from polyethylene, polypropylene, nylon or other material capable of resisting deterioration from the electrolyte.

FIG. 5 illustrates how the first gas cathode 4 and the second gas cathode 6 are disposed with respect to one another. The gas cathodes 4 and 6 can be any suitable gas cathodes known in the industry. Typical gas cathodes useable in the invention are manufactured by both Eltech Research Corporation and Alupower, Inc. As can be seen, both the first gas cathode 4 and the second gas cathode 6 comprise a wire mesh 144. A laterally disposed current collector 96 is disposed along the top edges of each gas cathode 4 and 6. In the embodiment illustrated in the drawings, two pairs of electrical contacts 98 extend from each current collector 96. When the second retaining structure 16 is disposed in the first retaining structure position, each pair of electrical contacts 98 are in physical contact with one another. In this way, the two gas cathodes 4 and 6 are electrically connected to one another.

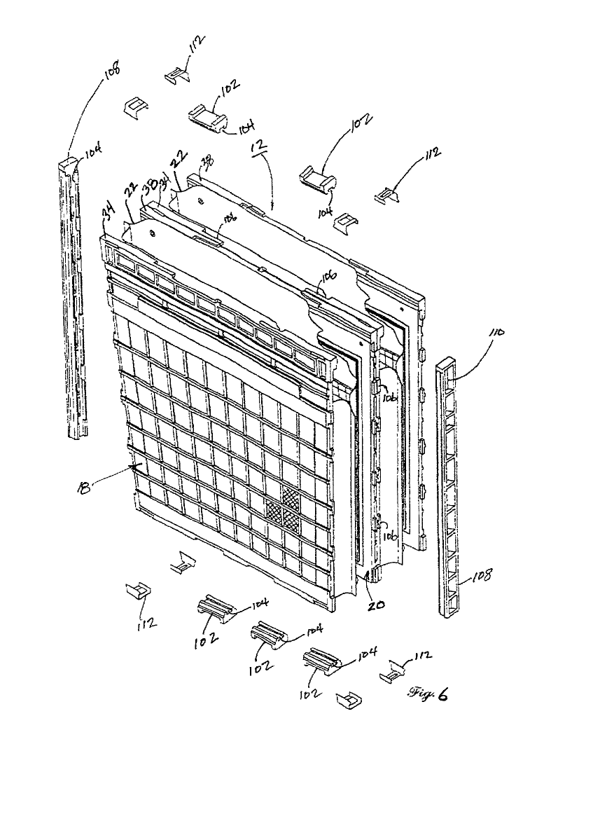

FIG. 6 illustrates an exploded view of the assembly of two adjoining battery cells 20. In the embodiment illustrated in FIG. 6, connecting blocks 102 are disposed at the top and the bottom to lock the second retaining structure 16 of a first battery cell 20′ to the first retaining structure 14 of a second battery cell 20″. The connecting blocks 102 have a female swallow-tailed slot 104 and the two adjoining retaining structures 14 and 16 combine to form a male swallow-tailed tenon 106 which is sized and dimensioned to be connected with the connecting blocks 102. Also in FIG. 6 are illustrated a pair of side connecting bars 108. Each connecting bar 108 has a number of swallow-tailed slots 104 which are sized and dimensioned to connect over swallow-tailed tenons 106 provided by the two adjoining retaining structures 14 and 16. The connecting bar 108 has a plurality of openings 146 to provide the influx of air into the battery cells 20.

FIG. 6 further illustrates the construction of a pair of interconnected slide fasteners which provide expansion restrainers 112 to prevent the expansion of each cell 20 beyond the second retaining structure position.

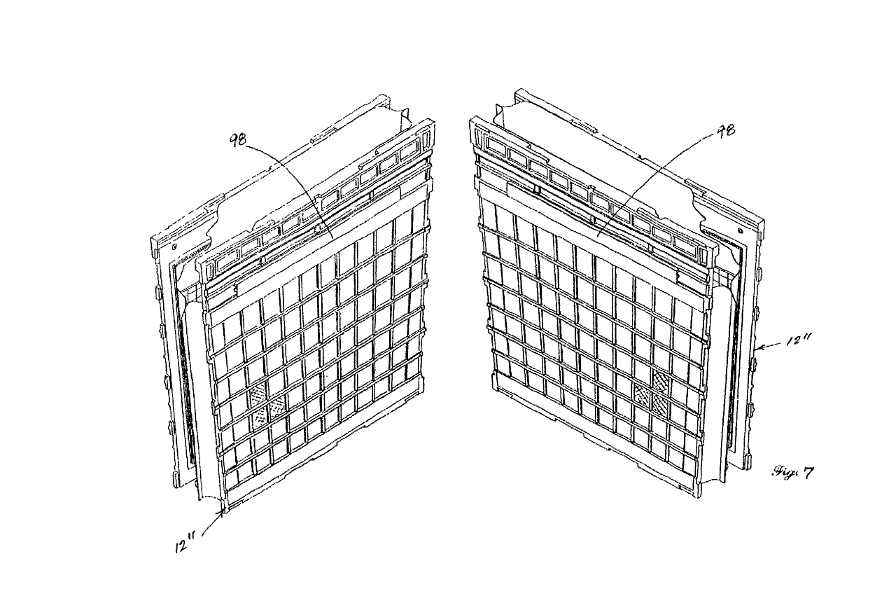

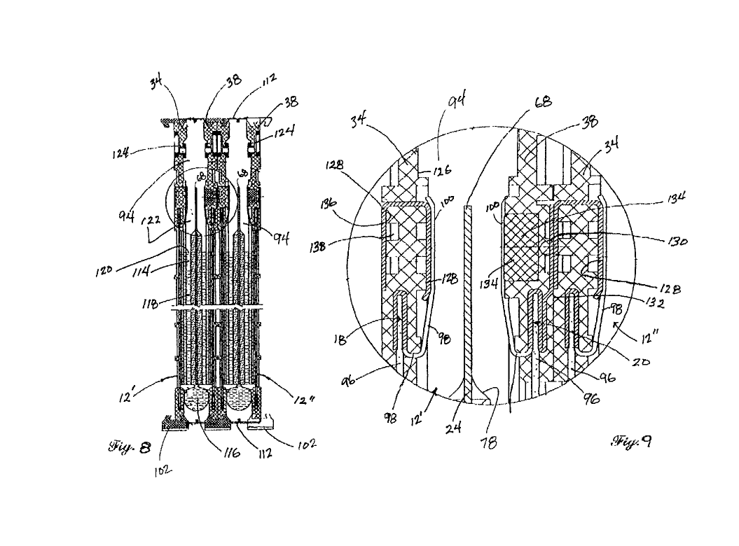

FIG. 7 illustrates a pair of fully assembled battery cells 20 which can be disposed adjacent to one another as illustrated in FIGS. 8 and 9.

FIG. 8 illustrates a cross-sectional view of a typical pair of battery cells 20 useable in the battery 10 of the invention. In FIG. 8, a first battery cell 20′ is disposed in abutment with a second battery cell 20″. Both battery cells 20′ and 20″ are shown in the second retaining structure position wherein the first retaining structure 14 of each cell 20 is spaced apart from the corresponding second retaining structure 16. As illustrated in FIG. 8, the soft pocket top opening 22 of each cell 20 comprises the expansion restrainers 112 which limit the expansion of the soft pocket top opening 22 of each cell 20 beyond the second restraining structure position. Except for the expansion restrainers 112, the soft pocket top opening 22 of each cell 20 is wholly open, so that the anode 30 within each cell 20 can be easily withdrawn from the soft pocket 40, and so that a new anode 30 can be easily inserted into each soft pocket 40. When the first and second retaining structures 14 and 16 are in the first retaining structure position, the soft pocket top opening 22 is tightly closed.

As further illustrated in FIG. 8, the battery 10 of the invention operates with an electrolyte 114 disposed within the soft pocket chamber 60. The electrolyte 114 is typically an aqueous solution of potassium hydroxide, sodium hydroxide or sodium chloride. Excess electrolyte 114 for each cell 20 is stored within a collapsible electrolyte reservoir 116 disposed at the base of the soft pocket chamber 76. The electrolyte 114 is disposed within a lower portion 118 of the soft pocket 40. That portion of the soft pocket chamber 60 above the liquid level 122 of the electrolyte 114 is referred to herein as the upper portion 122 of the soft pocket chamber 60.

In the embodiment illustrated in the drawings, the pressure balance within each cell 20 is provided by a semi-permeable membrane 126 disposed in the upper portion 122 of the soft pocket chamber 60. Such semi-permeable membrane 126 can be made from PTFE or other suitable semi-permeable membrane material. Any gas generated inside the battery cell 20 flows through the semi-permeable membrane 126 to the atmosphere. Thus, the battery 10 of this embodiment requires no breathing holes in the cell housing or in the top of the anode 30 as is common in prior art metal-gas cell designs. By the design of this embodiment, liquid and mist within the cell 20 are wholly contained within the cell 20 and are not allowed to leak externally of the cell 20.

FIG. 9 is a detailed view of a portion of the first battery cells 20 illustrated in FIG. 8. As can be seen from FIG. 9, when the second retaining structures 16 are moved from the second retaining structure position (as illustrated in FIGS. 8 and 9) to the first retaining structure position (i.e., wherein the soft pocket top openings 22 are tightly closed), the tab portion S8 of the anode support structure 54 is firmly retained between the first restraining structure 14 and the second retaining structure 16. Molded into the first retaining structure 14 is a U-shaped conductor element 128, which contacts the tab portion 58 of the anode support structure 54. The U-shaped conductor element 128 in the first retaining structure 14 of the first cell 20′ is electrically connected to the gas cathodes 4 and 6 of an adjoining cell 20″ (or to the negative second battery terminal if the first cell 20′ is an outermost cell). The U-shaped conductor element 128 in the first retaining structure 14 of the second cell 20″ is electrically connected to the gas cathodes 4 and 6 in the first cell 20′ by contact with a gas cathode conductor member 132 extending from the current collector 96 and disposed at the external surface 134 of the second retaining structure 16 of the first cell 20′. Where the gas cathode conductor member 132 is disposed within an outermost cell 20, the gas cathode conductor member 132 is in direct electrical contact with the positive first battery terminal 2. To facilitate the electrical contact between the U-shaped conductor element 128 and the gas cathode conductor member 132, the contacting surfaces of the U-shaped conductor element 128 and the gas cathode conductor member 132 can be coated with silver or other suitable material to prevent possible oxidation of their respective contacting surfaces.

The second retaining structure 16 proximate to the tab portion 58 of an anode 30, which is disposed within the soft pocket 40, comprises a resilient retaining member 134. Thus, when the second retaining structure 16 is in the first retaining structure position with respect to the first retaining structure 14, the tab portion 58 of an anode 30 disposed within the soft pocket 40 is firmly retained between the second retaining structure 16 and the U-shaped conductor element 128.

The U-shaped conductor element 128 also operates to conduct heat out of the battery cell 20. In the embodiment illustrated in the drawings, the heat can be dissipated by air flowing by the inner surface 138 of the U-shaped conductor element 128 through lateral passageways 142 disposed within each retaining structure 14 and 16. The electrical contacts 98 extending from the current collectors 96 also operate to conduct heat out of the battery cell 20. The current collectors 96 are tightly pressed against the metallic mesh 144, which comprises the surfaces of the gas cathodes 4 and 6. Accordingly, the current collectors 96 conduct heat generated within the battery cell 20 to the airside surfaces of the gas cathodes 4 and 6.

The invention provides a metal-gas cell battery, such as a zinc-air battery, which is suitable for rapid refueling and which is sufficiently durable for hundreds of refueling operations. The invention also provides a metal-gas cell battery, which does not leak electrolyte or electrolyte fumes.

Having thus described the invention, it should be apparent that numerous structural modifications and adaptations may be resorted to without departing from the scope and fair meaning of the instant invention as set forth hereinabove and as described herein below by the claims.

1. A metal-gas cell storage battery comprising:
(a) at least one battery cell comprising:
(i) a first gas cathode disposed within a rigid planar first retaining structure, the first gas cathode being permeable to gases but impermeable to liquids, the first gas cathode allowing the passage of gases into the cell;
(ii) a second gas cathode disposed within a rigid planar second retaining structure, the second gas cathode being permeable to air but impermeable to liquids, the second gas cathode allowing the passage of gases into the cell, the second retaining structure being moveable with respect to the first retaining structure between a first retaining structure position wherein the first retaining structure is proximate to the second retaining structure and a second retaining structure position wherein the first retaining structure is spaced apart from the second retaining structure, the second gas cathode being electrically connected to the first gas cathode;
(iii) a soft pocket disposed between the first gas cathode and the second gas cathode, the soft pocket having a flexible and planar first wall and a flexible and planar second wall, the first wall having a periphery and a central opening, the periphery of the first wall including a top edge, the second wall having a periphery and a central opening, the periphery of the second wall including a top edge, the periphery of the first wall being connected to the periphery of the second wall except along the respective top edges, the periphery of the first wall being attached to the first retaining structure and the periphery of the second wall being attached to the second retaining structure, whereby the first retaining structure, the first gas cathode, the first wall, the second wall, the second retaining structure and the second gas cathode cooperate to define a liquid retaining soft pocket chamber having a soft pocket lower portion, a soft pocket upper portion and a soft pocket top opening defined between the top edges of the first and second walls, the soft pocket top opening being open in the second retaining structure position and tightly closed in the first retaining structure position;
(iv) a soft pocket closing mechanism for securing the first and second retaining structures in the first retaining structure position; and
(v) a metallic anode disposed within the soft pocket chamber;
(b) a positive first battery terminal electrically connected to the two gas cathodes; and
(c) a negative second battery terminal electrically connected to the metallic anode.

2. The metal-gas cell storage battery of claim 1 wherein the battery cell further comprises an electrolyte disposed within the soft pocket chamber.

3. The metal-gas cell storage battery of claim 2 wherein the electrolyte is an aqueous solution containing a compound chosen from the group of compounds consisting of potassium hydroxide, sodium hydroxide and sodium chloride.

4. The metal-gas cell storage battery of claim 2 wherein the electrolyte is an aqueous solution containing potassium hydroxide.

5. The metal-gas cell storage battery of claim 1 wherein a semi-permeable membrane is disposed in the soft pocket upper portion to allow gases to flow out of the soft pocket upper portion, the semi-permeable membrane being permeable to gases but being impermeable to liquids.

6. The metal-gas cell storage battery of claim 5 wherein the semi-permeable membrane is made of PTFE.

7. The metal-gas cell storage battery of claim 1 wherein the soft pocket closing mechanism comprises at least one strap.

8. The metal-gas cell storage battery of claim 1 wherein the soft pocket closing mechanism comprises a plurality of straps.

9. The metal-gas cell storage battery of claim 1 wherein the top opening comprises expansion restrainers to limit the expansion of the top opening of the soft pocket beyond the first retaining structure position.

10. The metal-gas cell storage battery of claim 1 wherein the metallic anode comprises a planar anode base portion and a tab portion.

11. The metal-gas cell storage battery of claim 10 wherein the anode base portion is disposed within an enclosure bag.

12. The metal-gas cell storage battery of claim 10 wherein the anode base portion has a lower edge and an upper edge, the lower edge of the anode base portion being shorter in length than the upper edge of the anode base portion.

13. The metal-gas cell storage battery of claim 12 wherein the anode base portion is trapezoidal in shape.

14. The metal-gas cell storage battery of claim 1 wherein the metallic anode comprises an electrically conductive support structure to which is attached a metallic anode material.

15. The metal-gas cell storage battery of claim 14 wherein the metallic anode material is zinc.

16. The metal-gas cell storage battery of claim 1 wherein the first and second gas cathodes are first and second air cathodes, respectively.

17. The metal-gas cell storage battery of claim 1 wherein, when the first and second retaining structures are in the second retaining structure position, the metallic anode is retained firmly within the soft pocket by a resilient retaining member.

18. The metal-gas cell storage battery of claim 17 wherein the resilient retaining member is disposed within the second retaining structure.

19. The metal-gas cell storage battery of claim 1 wherein the at least one battery cell is a plurality of battery cells.

20. The metal-gas cell storage battery of claim 19 wherein the plurality of battery cells are electrically connected in series.

21. The metal-gas cell storage battery of claim 10 wherein the battery comprises a plurality of internal cells sandwiched between a first outermost cell and a second outermost cell, the tab portion of the anode in each internal cell being electrically connected to the gas cathodes of an adjoining cell by a conductor member, the conductor member having a portion which is in abutment with the tab portion of said anode.

22. A metal-gas cell storage battery comprising:
(a) at least one battery cell comprising:
(i) a first gas cathode disposed within a rigid planar first retaining structure, the first gas cathode being permeable to gases but impermeable to liquids, the first gas cathode allowing the passage of gases into the cell;
(ii) a second gas cathode disposed within a rigid planar second retaining structure, the second gas cathode being permeable to air but impermeable to liquids, the second gas cathode allowing the passage of gases into the cell, the second retaining structure being moveable with respect to the first retaining structure between a first retaining structure position wherein the first retaining structure is proximate to the second retaining structure and a second retaining structure position wherein the first retaining structure is spaced apart from the second retaining structure, the second gas cathode being electrically connected to the first gas cathode;
(iii) a soft pocket disposed between the first gas cathode and the second gas cathode, the soft pocket having a flexible and planar first wall and a flexible and planar second wall, the first wall having a periphery and a central opening, the periphery of the first wall including a top edge, the second wall having a periphery and a central opening, the periphery of the second wall including a top edge, the periphery of the first wall being connected to the periphery of the second wall except along the respective top edges, the periphery of the first wall being attached to the first retaining structure and the periphery of the second wall being attached to the second retaining structure, whereby the first retaining structure, the first gas cathode, the first wall, the second wall, the second retaining structure and the second gas cathode cooperate to define a liquid retaining soft pocket chamber having a soft pocket lower portion, a soft pocket upper portion and a soft pocket top opening defined between the top edges of the first and second walls, the soft pocket top opening being open in the second retaining structure position and tightly closed in the first retaining structure position;
(iv) a soft pocket closing mechanism for securing the first and second retaining structures in the first retaining structure position; and
(v) a metallic anode wholly disposed within the soft pocket chamber;
(b) a positive first battery terminal electrically connected to the two gas cathodes; and
(c) a negative second battery terminal electrically connected to the metallic anode.

23. The metal-gas cell storage battery of claim 22 wherein the battery cell further comprises an electrolyte disposed within the soft pocket chamber.

24. The metal-gas cell storage battery of claim 23 wherein the electrolyte is an aqueous solution containing a compound chosen from the group of compounds consisting of potassium hydroxide, sodium hydroxide and sodium chloride.

25. The metal-gas cell storage battery of claim 23 wherein the electrolyte is an aqueous solution containing potassium hydroxide.

26. The metal-gas cell storage battery of claim 22 wherein a semi-permeable membrane is disposed in the soft pocket upper portion to allow gases to flow out of the soft pocket upper portion, the semi-permeable membrane being permeable to gases but being impermeable to liquids.

27. The metal-gas cell storage battery of claim 26 wherein the semi-permeable membrane is made of PTFE.

28. The metal-gas cell storage battery of claim 22 wherein the soft pocket closing mechanism comprises at least one strap.

29. The metal-gas cell storage battery of claim 22 wherein the soft pocket closing mechanism comprises a plurality of straps.

30. The metal-gas cell storage battery of claim 22 wherein the top opening comprises expansion restrainers to limit the expansion of the top opening of the soft pocket beyond the first retaining structure position.

31. The metal-gas cell storage battery of claim 22 wherein the metallic anode comprises a planar anode base portion and a tab portion.

32. The metal-gas cell storage battery of claim 31 wherein the anode base portion is disposed within an enclosure bag.

33. The metal-gas cell storage battery of claim 31 wherein the anode base portion has a lower edge and an upper edge, the lower edge of the anode base portion being shorter in length than the upper edge of the anode base portion.

34. The metal-gas cell storage battery of claim 33 wherein the anode base portion is trapezoidal in shape.

35. The metal-gas cell storage battery of claim 22 wherein the metallic anode comprises an electrically conductive support structure to which is attached a metallic anode material.

36. The metal-gas cell storage battery of claim 35 wherein the metallic anode material is zinc.

37. The metal-gas cell storage battery of claim 22 wherein the first and second gas cathodes are first and second air cathodes.

38. The metal-gas cell storage battery of claim 22 wherein, when the first and second retaining structures are in the second retaining structure position, the metallic anode is retained firmly within the soft pocket by a resilient retaining member.

39. The metal-gas cell storage battery of claim 38 wherein the resilient retaining member is disposed within the second retaining structure.

40. The metal-gas cell storage battery of claim 22 wherein the at least one battery cell is a plurality of battery cells.

41. The metal-gas cell storage battery of claim 40 wherein the plurality of battery cells are electrically connected in series.

42. The metal-gas cell storage battery of claim 31 wherein the battery comprises a plurality of internal cells sandwiched between a first outermost cell and a second outermost cell, the tab portion of the anode in each internal cell being electrically connected to the gas cathodes of an adjoining cell by a conductor member, the conductor member having a portion which is in abutment with the tab portion of said anode.

43. A zinc-air cell storage battery comprising:
(a) a plurality of internal battery cells sandwiched between a first outermost battery cell and a second outermost battery cell, each battery cell comprising:
(i) a first gas cathode disposed within a rigid planar first retaining structure, the first gas cathode being permeable to gases but impermeable to liquids, the first gas cathode allowing the passage of gases into the cell;
(ii) a second gas cathode disposed within a rigid planar second retaining structure, the second gas cathode being permeable to air but impermeable to liquids, the second gas cathode allowing the passage of gases into the cell, the second retaining structure being moveable with respect to the first retaining structure between a first retaining structure position wherein the first retaining structure is proximate to the second retaining structure and a second retaining structure position wherein the first retaining structure is spaced apart from the second retaining structure, the second gas cathode being electrically connected to the first gas cathode;
(iii) a soft pocket disposed between the first air cathode and the second air cathode, the soft pocket having a flexible and planar first wall and a flexible and planar second wall, the first wall having a periphery and a central opening, the periphery of the first wall including a top edge, the second wall having a periphery and a central opening, the periphery of the second wall including a top edge, the periphery of the first wall being connected to the periphery of the second wall except along the respective top edges, the periphery of the first wall being attached to the first retaining structure and the periphery of the second wall being attached to the second retaining structure, whereby the first retaining structure, the first air cathode, the first wall, the second wall, the second retaining structure and the second air cathode cooperate to define a liquid retaining soft pocket chamber having a soft pocket lower portion, a soft pocket upper portion and a soft pocket top opening defined between the top edges of the first and second walls, the soft pocket top opening being open in the second retaining structure position and tightly closed in the first retaining structure position;
(iv) a soft pocket closing mechanism for securing the first and second retaining structures in the first retaining structure position;
(v) a zinc anode wholly disposed within the soft pocket chamber, the zinc anode comprising a planar anode base portion and a tab portion, the anode base portion having a lower edge and an upper edge, the lower edge of the anode base portion being shorter in length than the upper edge of the anode base portion; and
(vi) a semi-permeable membrane disposed in the soft pocket upper portion to allow gases to flow out of the soft pocket upper portion, the semi-permeable membrane being permeable to gases but being impermeable to liquids;
(b) a positive first battery terminal electrically connected to the two air cathodes of the first outermost battery cell; and
(c) a negative second battery terminal electrically connected to the zinc anode of the second outermost battery cell;
wherein the tab portion of the anode in each internal cell is electrically connected to the air cathodes of an adjoining battery cell by a conductor member, the conductor member having a portion which is in abutment with the tab portion of said anode.

44. The zinc-air cell storage battery of claim 43 wherein each battery cell further comprises an electrolyte disposed within the soft pocket chamber.

45. The zinc-air cell storage battery of claim 44 wherein the electrolyte is an aqueous solution containing a compound chosen from the group of compounds consisting of potassium hydroxide, sodium hydroxide and sodium chloride.

46. The zinc-air cell storage battery of claim 44 wherein the electrolyte is an aqueous solution containing potassium hydroxide.

47. The zinc-air cell storage battery of claim 43 wherein the second semi-permeable membrane in each cell is made of PTFE.

48. The zinc-air cell storage battery of claim 43 wherein the soft pocket closing mechanism in each cell comprises at least one strap.

49. The zinc-air cell storage battery of claim 43 wherein the soft pocket closing mechanism in each cell comprises a plurality of straps.

50. The zinc-air cell storage battery of claim 43 wherein the top opening in each cell comprises expansion restrainers to limit the expansion of the top opening of the soft pocket beyond the first retaining structure position.

51. The zinc-air cell storage battery of claim 43 wherein the anode base in each cell portion is disposed within an enclosure bag.

52. The zinc-air cell storage battery of claim 43 wherein the anode base in each cell portion is trapezoidal in shape.

53. The zinc-air cell storage battery of claim 43 wherein the zinc anode in each cell comprises an electrically conductive support structure to which is attached a zinc anode material.

54. The zinc-air cell storage battery of claim 43 wherein, when the first and second retaining structures in each cell are in the second retaining structure position, the zinc anode is retained firmly within the soft pocket by a resilient retaining member.

55. The zinc-air cell storage battery of claim 54 wherein the resilient retaining member in each cell is disposed within the second retaining structure.

56. The zinc-air cell storage battery of claim 43 wherein the plurality of battery cells are electrically connected in series.
